(19) United States
(12) Patent Application Publication
(10) Pub. No.: US 2019/0255454 A1
(43) Pub. Date: Aug. 22, 2019

(54) APPARATUS AND METHOD FOR PRODUCING ART FROM A SHAPED MALLEABLE COMPOUND

(71) Applicant: Relevant Play, LLC, Denver, CO (US)

(72) Inventors: Denise Arias, Milford, NJ (US); Henry Arias, Milford, NJ (US); David McCloskey, Erie, CO (US); Johnny Eisert, Loveland, CO (US)

(21) Appl. No.: 16/279,848

(22) Filed: Feb. 19, 2019

Related U.S. Application Data
(60) Provisional application No. 62/632,331, filed on Feb. 19, 2018.

(51) Int. Cl. A63H 33/00; B29C 43/02

(52) U.S. Cl. CPC A63H 33/001; B29C 2043/3283; B29C 43/021

(57) ABSTRACT

An apparatus and method for shaping a malleable compound including a major frame, a mesh secured to a minor frame, the mesh having an upper surface and a lower surface and the minor frame engaged with the major frame. In addition, a tray is disposed beneath the mesh and is separable from the major frame, mesh and minor frame. To assist in the formation of the shaped malleable material, a cutter of a desired pattern with a lower edge, an upper surface and an open extended interior spanning between the lower edge and the upper surface is utilized. The lower edge of the cutter is placed over the mesh atop the malleable compound and hand pressure is applied to the cutter causing the malleable compound to extrude through the mesh past the lower edge into the open interior of the cutter resulting in the malleable compound taking on the shaped of the desired pattern.

### RELATED APPLICATION

This application claims priority to U.S. Patent Application Ser. No. 62/632,331, filed Feb. 19, 2018, and incorporated herein by reference.

### TECHNICAL FIELD

The present disclosure relates to an apparatus, system and method for forming art using a malleable compound.

### BACKGROUND

A malleable compound (e.g., “Mad Mattr®” from Waba Fun Inc., Playdough®) makes an enjoyable toy for children (and adults). The compound retains its shape after manipulation.

### SUMMARY

Plastic modeling compounds used by children and adults for art and craft projects continue to be extremely popular. Developing shapes that are aesthetically appealing continues to hold widespread appeal to a large segment of the population and in particular young people. Disclosed herein is an an apparatus, system and method for relatively precise shaping of plastic modeling compounds (hereinafter “malleable compounds”) into those aesthetically pleasing forms by passing the compound through a mesh into a cutter with an open interior space.

A preferred embodiment of the apparatus includes a major frame, preferably in a square or rectangular configuration. The major frame includes a major frame top member and a major frame bottom member. The preferred embodiment also includes a mesh secured to a minor frame. The mesh includes an upper surface and a lower surface and the minor frame is disposed between the major frame top member and major frame bottom member. Disposed beneath the mesh is a tray that is separate from the major frame, mesh and minor frame. Next, the lower edge of a cutter with an upper surface and an open extended interior spanning between the lower edge and the upper surface is placed over the mesh atop a rolled sheet at the desired thickness of malleable compound that has been positioned beneath the minor frame and mesh but atop the tray.

Manual pressure is then applied to the cutter causing the malleable compound to extrude through the mesh past the lower edge into the open interior of the cutter resulting in the malleable compound taking on the shape of a desired pattern. Once the cutter lower edge reaches the surface of the tray, pressure applied to the cutter may be removed as the lower edge of the cutter has fully penetrated the sheet of malleable compound and contacted the surface of the tray. The major frame, minor frame and mesh are then lifted away from the malleable compound and the cutter is removed from contact with the mesh. The malleable material remaining on the mesh now unbounded by the cutter retains the shape of the cutter used to carve it from the sheet of malleable compound laid atop the tray.

In one embodiment, an apparatus for shaping a malleable compound includes a minor frame; a mesh secured to the minor frame, the mesh comprising an upper surface and a lower surface; at least one cutter having a lower edge defining a pattern, an upper surface and an open extended interior spanning between the lower edge and the upper surface. When the lower edge of the cutter is placed over the mesh atop the malleable compound and manual pressure is applied to the cutter, the malleable compound extrudes through the mesh past the lower edge and into the open extended interior of the cutter resulting in the malleable compound taking on a shape of the pattern.

In another embodiment, a system extrudes a malleable compound into a desired shape. The system includes a major frame with an upper major frame member and a lower major frame member, and a minor frame with an interior perimeter and an outer perimeter. The minor frame is disposed between the upper major frame member and the lower major frame member. The system also includes a mesh, having an upper surface and a lower surface, secured proximate the interior perimeter of the minor frame, a tray disposed beneath the mesh and operably separable from the major frame, mesh and minor frame, and a cutter of a desired pattern with a lower edge, an upper surface and an open extended interior spanning between the lower edge and the upper surface. The lower edge of the cutter is placed over the mesh atop the malleable compound and manual pressure is applied to the cutter causing the malleable compound to extrude through the mesh past the lower edge into the open extended interior of the cutter resulting in the malleable compound taking on a shape of the desired pattern.

In another embodiment, a method extrudes a malleable compound into a desired shape. The malleable compound is deposited beneath a taut mesh. A lower patterned edge of a cutter is positioned against an upper surface of the mesh and over the malleable compound. The mesh is depressed with the lower patterned edge of the cutter to extrude the malleable compound through the mesh and into an open extending interior space of the cutter, and the shaped malleable compound is removed from the interior space of the cutter to free a shape defined by the lower patterned edge.

Various objects, features, aspects and advantages of the inventive subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims.

### BRIEF DESCRIPTION OF THE DRAWINGS

FIG. 1 is a perspective view of an embodiment of a pop art frame for forming art using a malleable compound;

FIG. 2 is a perspective topside exploded view of the pop art frame of FIG. 1;

FIG. 3 is a perspective view of the major frame of the pop art frame of FIGS. 1 and 2;

FIG. 4 is a perspective bottom exploded view of the pop art frame of FIGS. 1-3;

FIG. 5 is a perspective view of the minor frame and mesh of FIG. 2;

FIG. 6 is a perspective view of the major frame bottom member of FIG. 2;

FIG. 7 is a perspective view of the tray of FIGS. 2 and 4;

FIG. 8 is a left side elevation view of the pop art frame of FIGS. 1-7 including the tray positioned there beneath;

FIG. 9 is a perspective view of an embodiment of a circular shaped cutter;

FIG. 10 is a perspective view of an embodiment of a square shaped cutter;

FIG. 11 is a perspective view of an embodiment of a heart shaped cutter;

FIG. 12 is a perspective view of an embodiment of a triangular shaped cutter;

FIG. 13 is a perspective view of an embodiment of a star shaped cutter;

FIG. 14 is a perspective view of an embodiment of the pop art frame with a plurality of cutters and malleable material positioned alongside the frame;

FIG. 15 is a perspective view of an embodiment of the pop art frame with a sheet of malleable compound positioned atop the tray;

FIG. 16 is a perspective view of an embodiment of the pop art frame with the sheet of malleable compound positioned atop the tray and beneath the mesh;

FIG. 17 is a perspective view of an embodiment of the pop art frame with a round cutter positioned atop the mesh over the sheet of malleable compound.

FIG. 18 is a perspective view of an embodiment of the pop art frame with a round cutter and hand applying downward pressure to the cutter and to the surface of the mesh;

FIG. 19 is a perspective view of an embodiment of the pop art frame with a cutaway of the cutter revealing extruded malleable compound extending into the open extended interior; and

FIG. 20 is a perspective view of an embodiment of the pop art frame with the major frame elevated away from the tray and the shaped malleable compound resting atop the mesh.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims

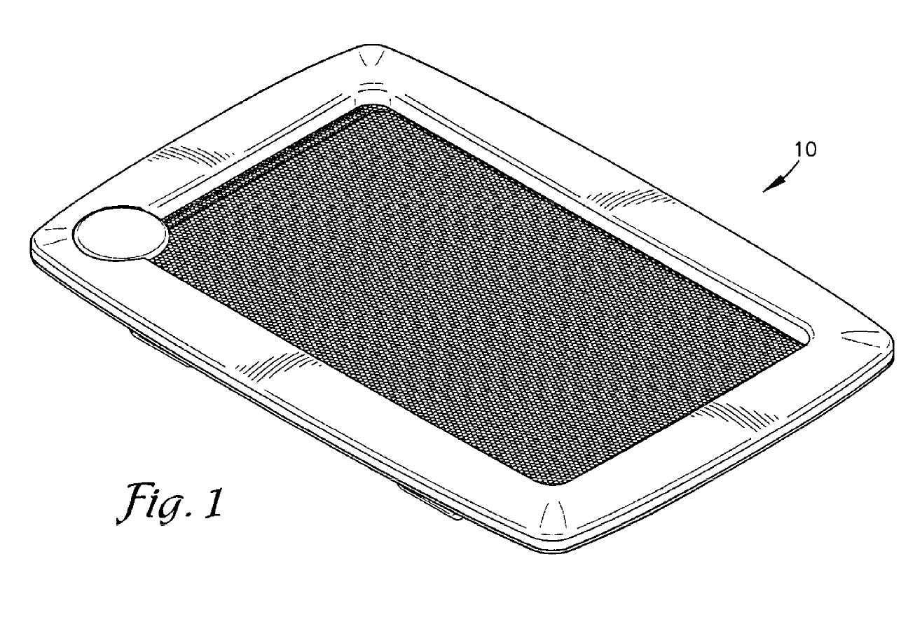

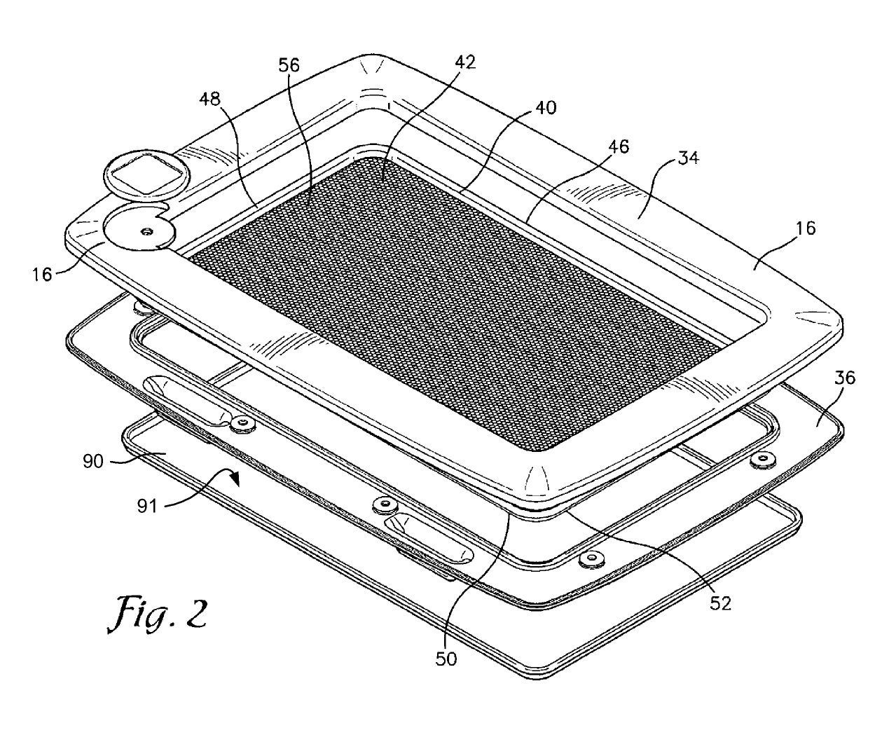

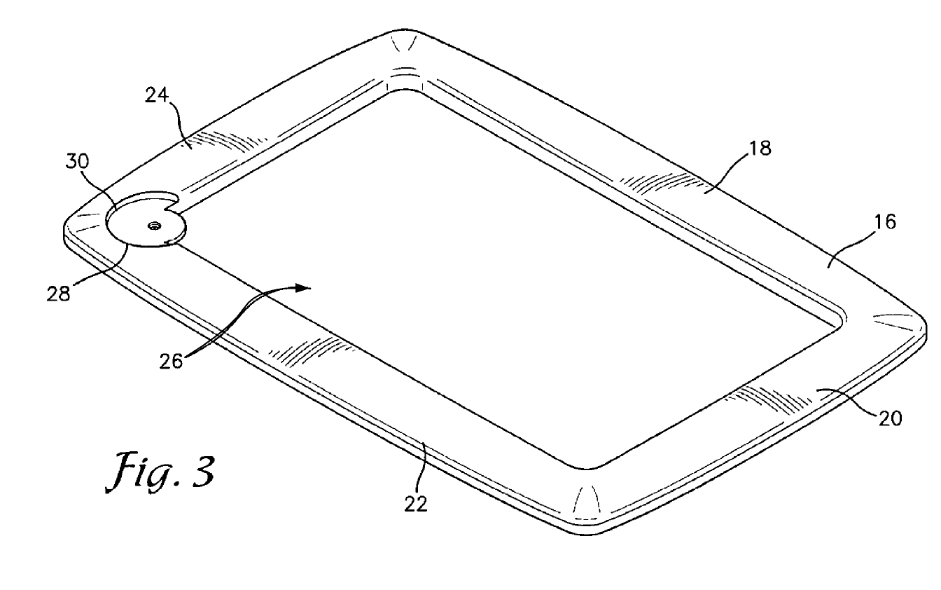

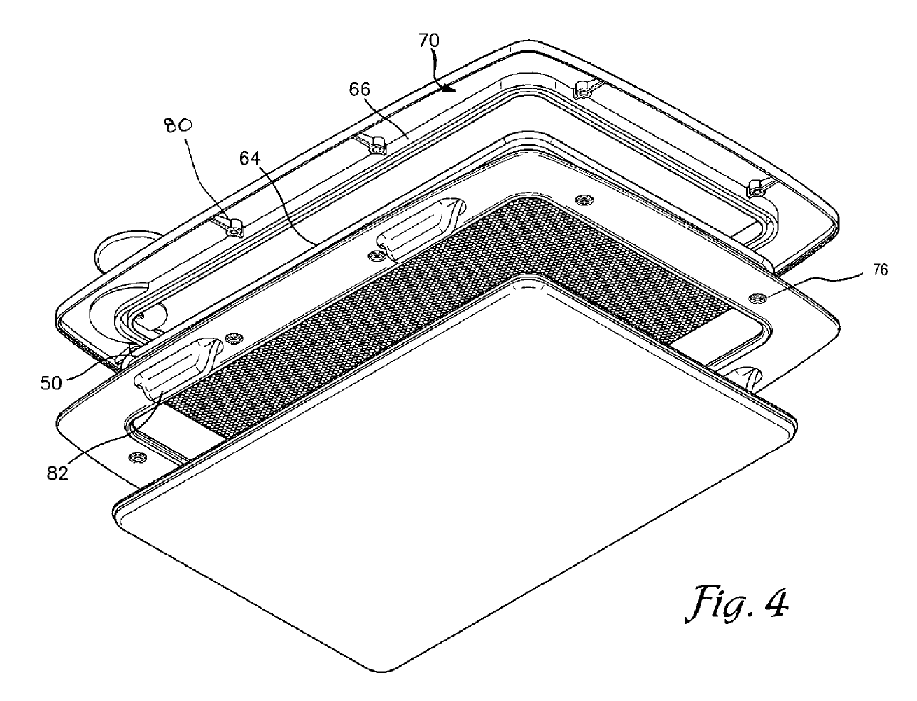

Disclosed herein is an apparatus and system for use in producing a plurality of shapes of malleable material. FIG. 1 reveals an exemplary view of the disclosed apparatus 10 known in marketing vernacular as a “pop art frame.” FIG. 2 reveals an exploded view of the apparatus 10 of FIG. 1 including a major frame 16. The apparatus 10 is shown positioned over a tray 90. As best seen in FIG. 3, the major frame 16 includes four frame segments 18, 20, 22, 24 that bound an open interior space 26. A corner 28 of the major frame 16 may include an area 30 for use in securing a rotatable disk, for example to display a corporate logo identifying the origin of the apparatus 10. As seen in FIGS. 2 and 4, the major frame 16 is further comprised of a major frame top member 34 and a major frame bottom member 36. Disposed between the top member 34 and bottom member 36 is a minor frame 40. As seen in FIG. 5, the minor frame 40 secures a mesh 42 between the four segments 46, 48, 50, 52 comprising the minor frame 40. The mesh 42 is preferably not tightly bound to the four segments but retains some elasticity to flex with the application of pressure to an upper surface 56 of the mesh 42.

As seen in FIG. 5, the minor frame mesh 42 preferably utilizes a hole 60 size in the range of from about 0.057 inches to 0.125 inches in diameter and also utilizes a mesh open area in the range of about 37 to 65 percent open. The mesh 42 also spans and is secured to all four segments 46, 48, 50, 52 of the minor frame 40 but is not so excessively tight that vertical flexure cannot be achieved by the force that a child might be capable of applying with her hands. The mesh must be capable of flexing downwardly roughly 0.375 inches at the center of the mesh, and to a lesser extent nearer the frame segments. Importantly, from both a functional and an aesthetic perspective, the mesh 42 has sufficient elasticity to return to its original shape and not deform and sag after many uses. For that reason, a mesh 42 fabricated from an elastic engineered polymer is preferred as compared to a mesh fabricated from a metal such as steel or aluminum.

As best seen in FIG. 4, the four segments 46, 48, 50, 52 of the minor frame 40 extend upwardly from the upper surface 56 of the mesh 42 and may include a small outwardly extending lip 64 that nests adjacent the intersection of a downwardly extending channel 66 and a bottom surface 70 of the major frame segments 18, 20, 22, 24. The segments 46, 48, 50, 52 of the minor frame are parallel to, and surrounded by, the downwardly extending channel 66 of the major frame segments 18, 20, 22, 24. The small outwardly extending lip 64 may contact the bottom surface 70 of the major frame top member 34. In one embodiment, the upwardly extending wall segments 46, 48, 50, 52 and the outwardly extending lip 64 provide a uniform base of support for the minor frame when installed against the bottom surface 70 of the major frame top member 34. In another embodiment, mesh 42 may be positioned over the downwardly extending channel 66 such that when the minor frame 40 is pressed into the channel, the mesh 42 is tensioned and secured.

As further detailed in FIGS. 2 and 4, the major frame bottom member 36 is disposed beneath the major frame top member 34 and serves to retain the minor frame 40 in position. When in fully assembled configuration, the outwardly extending lip 64 of the minor frame 40 is restrained inside the downwardly extending channel 66 of the major frame bottom member 36. The downwardly extending channel 66 effectively locks the minor frame segments of the minor frame 40 in position preventing movement of the minor frame.

As best seen in FIG. 4, the major frame bottom member 36 includes one or more fastener openings 76 in each of the segments 46, 48, 50, 52. The fastener openings 76 are aligned with bosses 80 descending downwardly from the bottom surface 70 of the major frame top member 34. For example, fasteners (e.g., screws not shown) may cut threads into the bosses 80 as the fastener is first rotated into the hole formed into the boss 80. When undergoing assembly, fasteners pass into multiple fastener openings 76 in the major frame bottom member 36 and then into the bosses 80 and are tightened. The head of the threaded fastener (not shown) pulls the major frame bottom member 36 tight against the bottom surface 70 of the major frame top member 34 locking the minor frame 40 in position between the major frame top member 34 and a major frame bottom member 36. Other fastening mechanism may be used to secure the major frame bottom member 36 to e major frame top member 34 without departing from the scope of the embodiments herein.

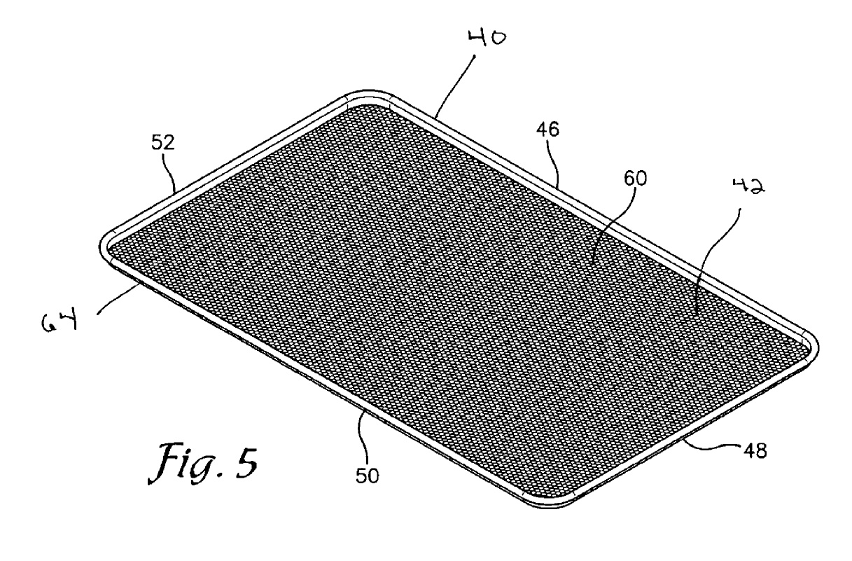

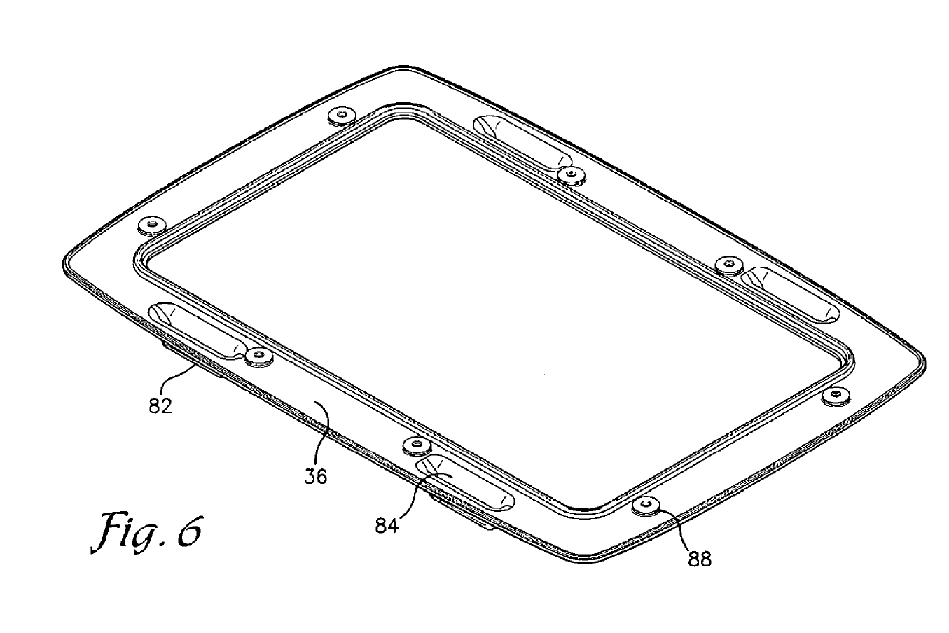

As best seen in FIG. 4, the major frame bottom member 36 utilizes two sets of downwardly extending leg members 82. The leg members 82 are preferably molded into the bottom member 36 on opposite sides in order to provide a stable platform when the apparatus 10 is in use and further serves to elevate the major and minor frames 16, 40 above the level of a supporting surface 91 of the tray 90. The extending leg members 82 project downwardly preferably in the range of from 0.25 to 0.5 inches; however, shorter or longer leg members also provide functionality of the apparatus. FIG. 6 reveals the indentations 84 formed into the major frame bottom member 36 that form the downwardly extending leg members 82. FIG. 6 also reveals the upper surfaces 88 of major frame bottom member 36 formed around the fastener openings 76 to meet the corresponding bosses 80.

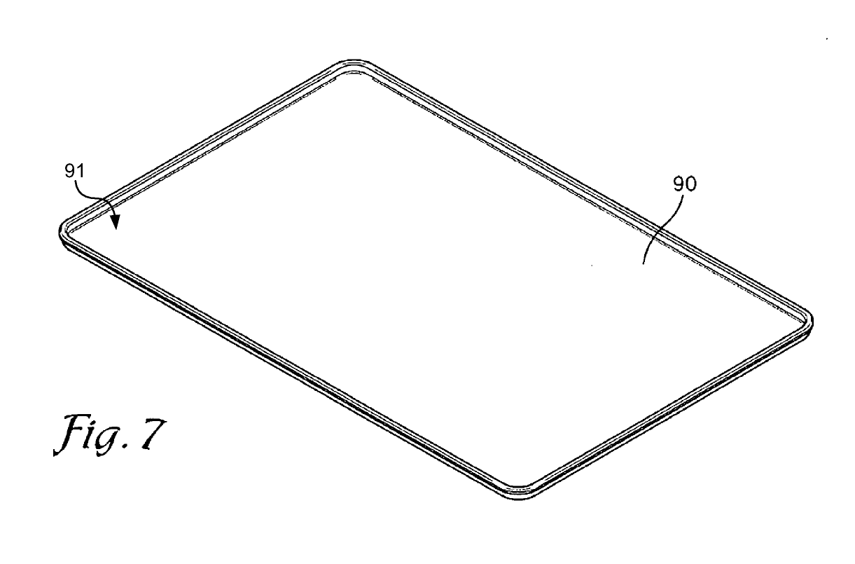

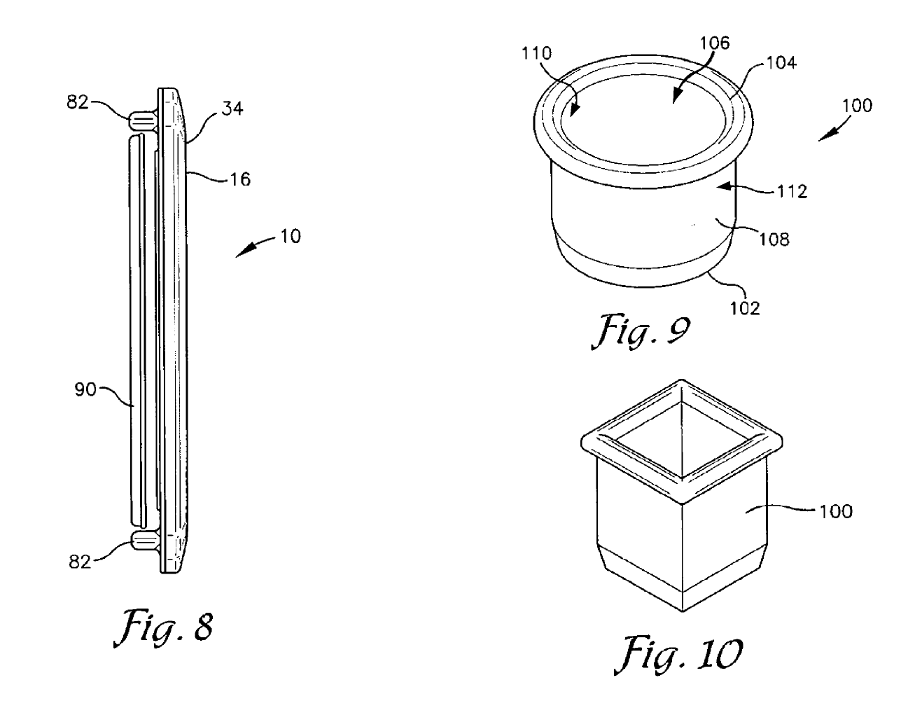

Shown at FIG. 7, in isolation, is the tray 90 of FIG. 2. The tray 90 may be positioned beneath the mesh 42, but unconnected to either of the major frame 16 or minor frame 40. The tray 90 is preferably of lateral and longitudinal dimensions relatively consistent with, but slightly less than, the major frame 16. As seen in FIG. 8, the tray 90 lateral dimension is preferably less than the distance between the downwardly extending leg members 82 on oppositely disposed sides of the major frame 16. This narrower dimension allows the tray 90 to rest on a supporting surface directly beneath the minor frame 40 but not interfere with the extending leg members 82.

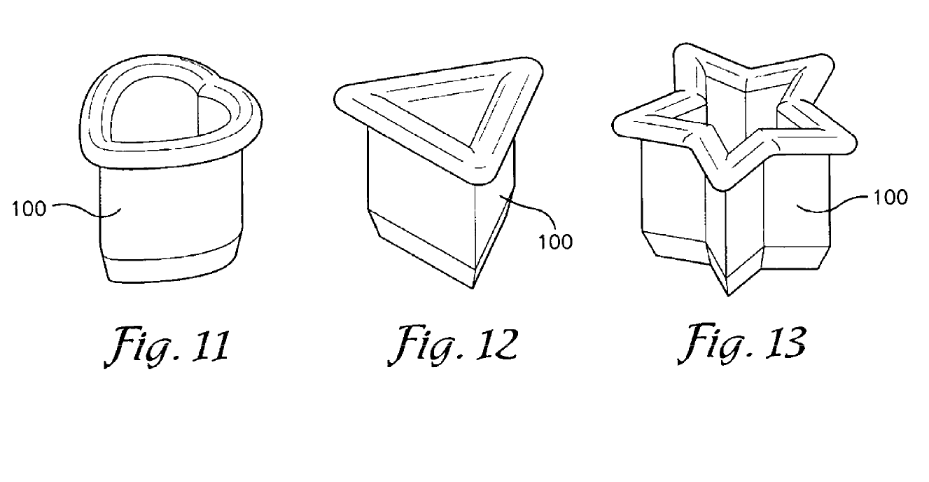

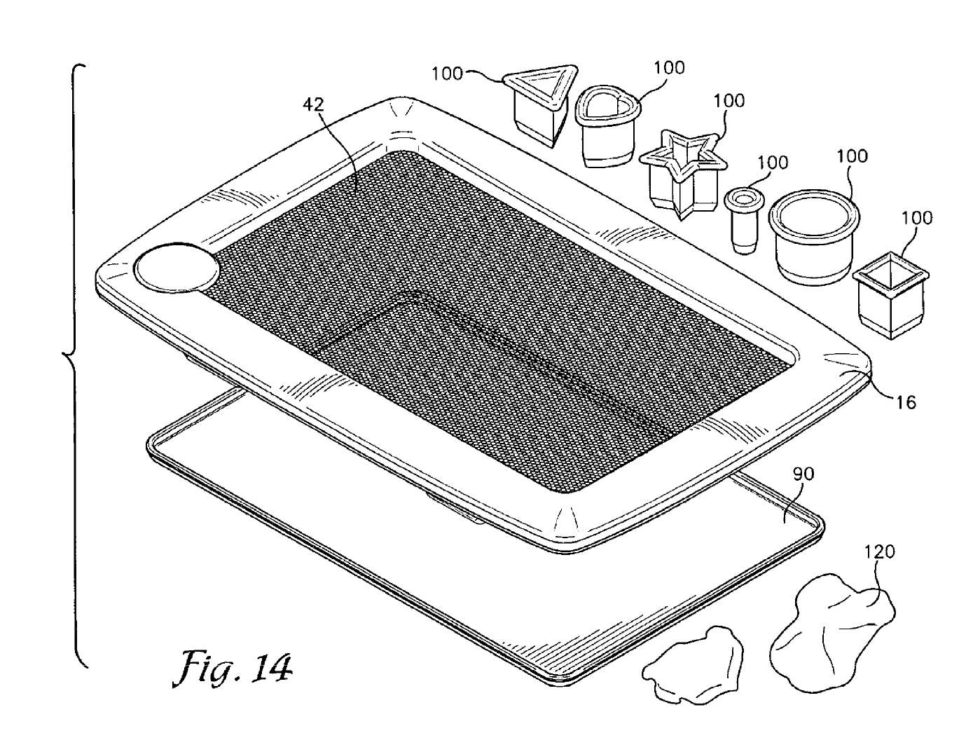

One or more cutters 100, the operation of which will be more thoroughly detailed below, are used to remove a pattern of malleable compound from a sheet positioned atop the tray. The cutters 100, examples of which are shown in FIGS. 9-13, are configured with a lower edge 102, an upper surface 104 and a wall 108 spanning between the lower edge 102 and an upper surface 104 to form an open extended interior 106. The wall 108 has an interior surface 110 and an exterior surface 112. Cutters 100 are configured in a wide range of sizes and open extended interior 106 patterns to include, among many other—circles (FIG. 9), squares (FIG. 10), hearts (FIG. 11), triangle (FIG. 12), and stars (FIG. 13).

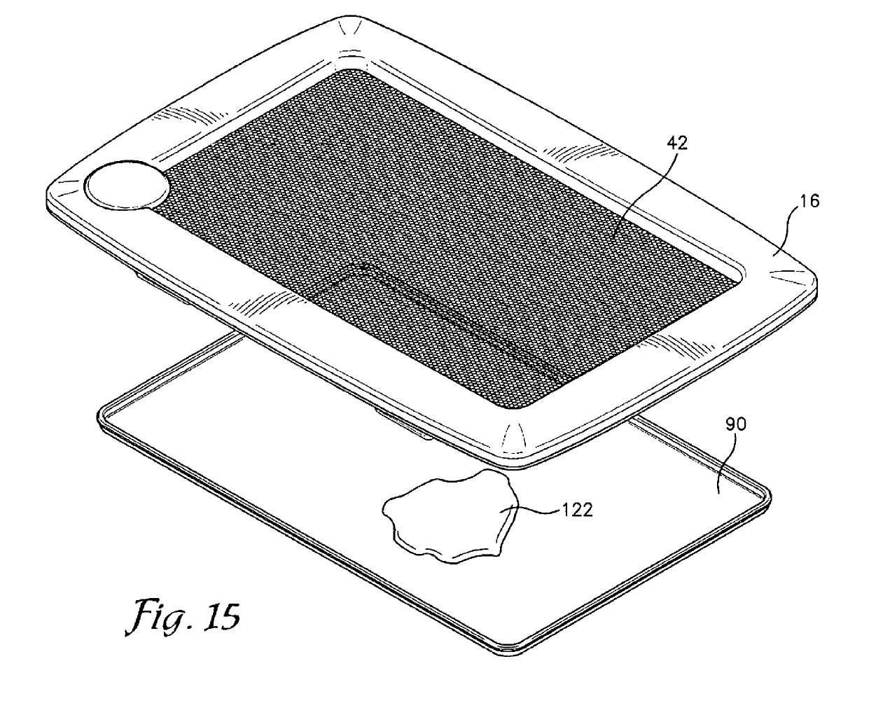

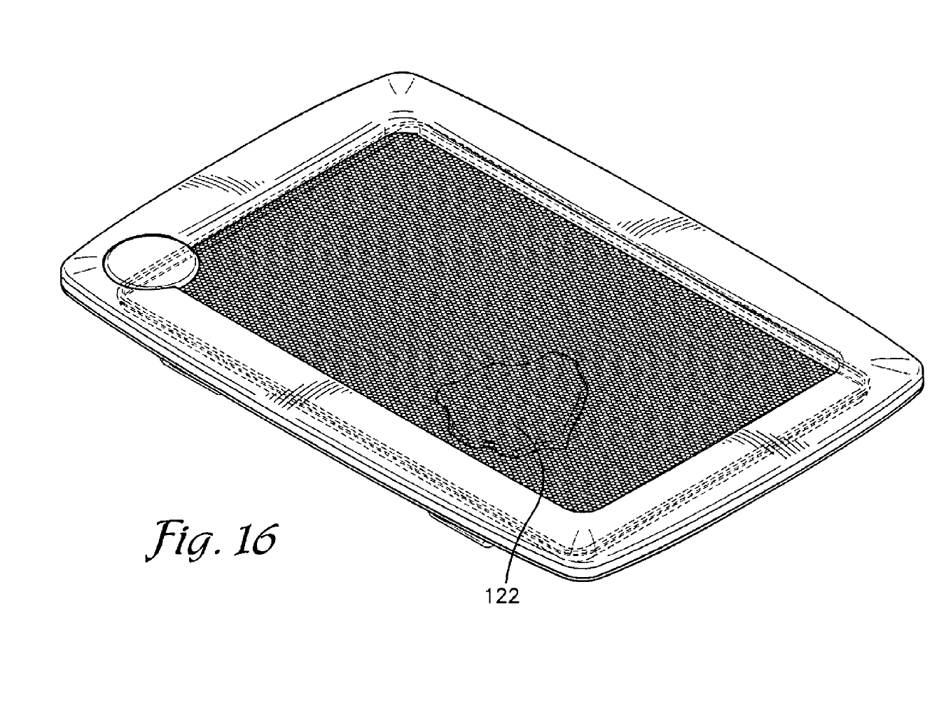

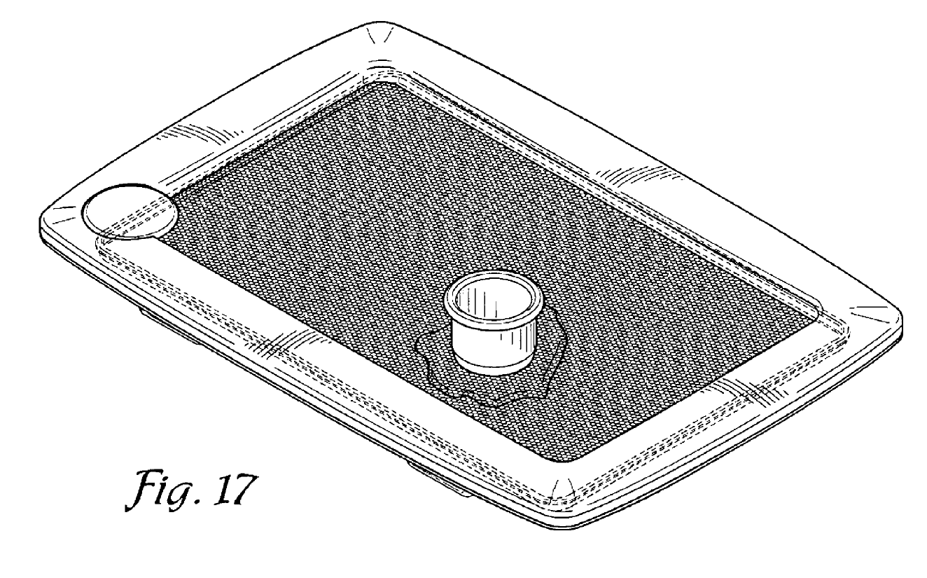

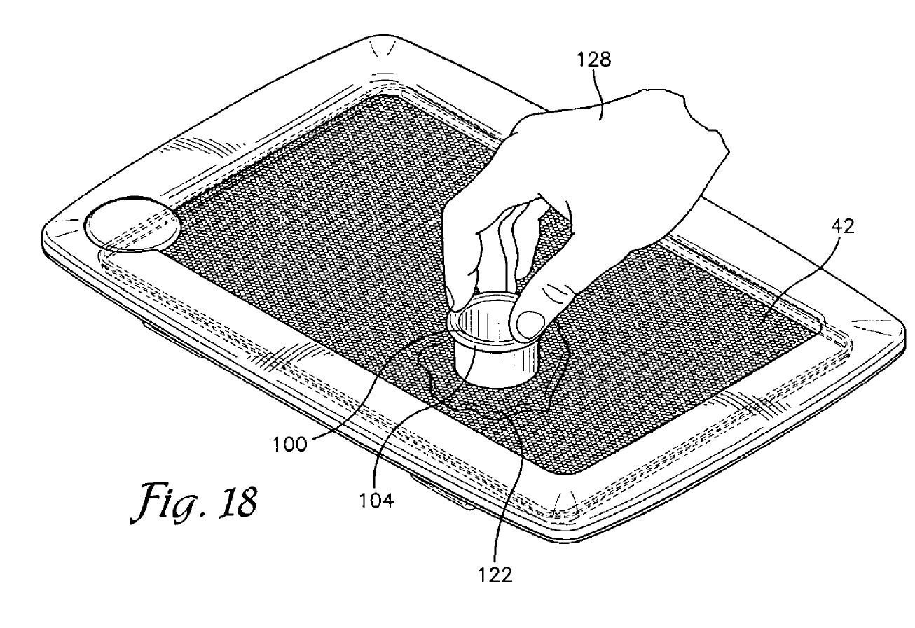

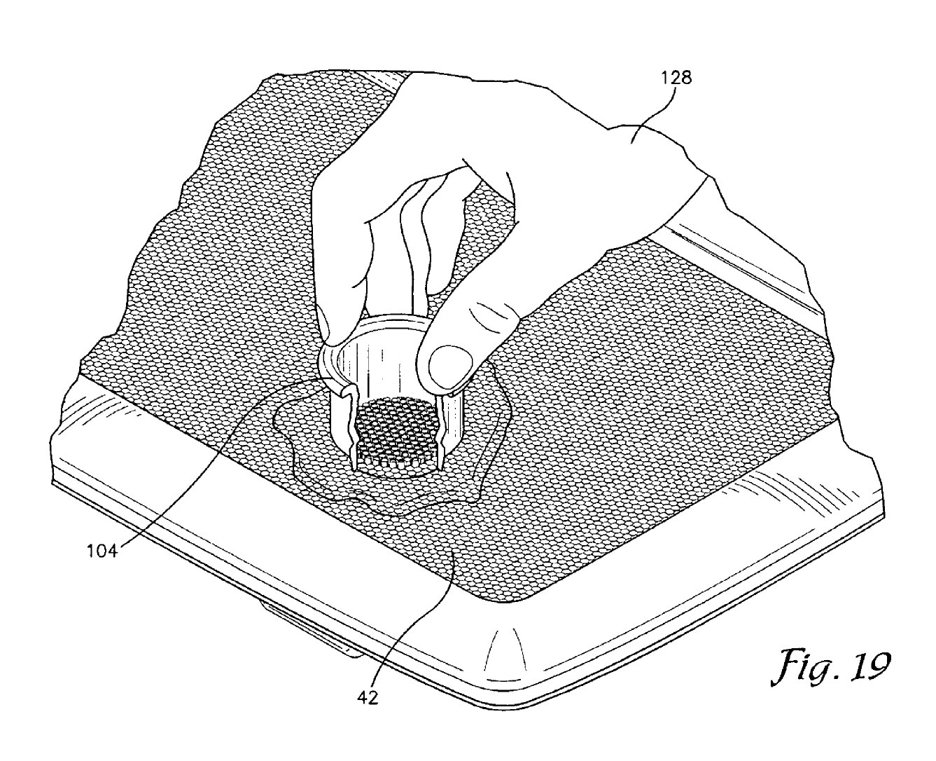

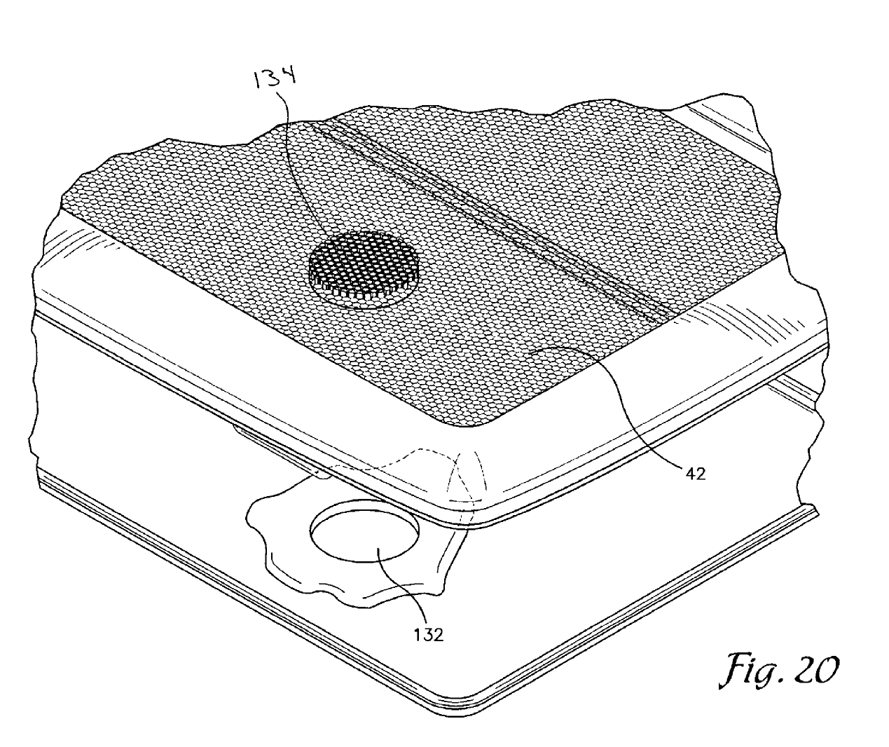

In one example of operation, as seen in FIGS. 14 and 15, the user obtains one or more samples of the malleable compound 120 and rolls it into a sheet 122 of the desired thickness. The malleable sheet 122 thickness is preferably in the range of from 0.125 inches to 0.50 inches and more preferably in the 0.25 to 0.375 inches range and is positioned atop the tray 90 and the major and minor frames 16, 40 and mesh 42 are then positioned over the tray 90 and the sheet 122 of the malleable compound 120 as shown in FIG. 16. FIG. 17 depicts a cutter 100 in position above the mesh 42 and over the sheet 122 of malleable compound 120. FIG. 18 depicts a hand 128 applying downward pressure to the upper surface 104 of the cutter 100. FIG. 19 reveals a cut-away view of a circular cutter 100 as a hand 128 applies pressure to the upper surface 104 driving the cutter 100 and the mesh 42 downward into the sheet 122 of malleable compound 120. As the cutter 100 is depressed, the malleable compound extrudes through the mesh 42 and enters into the open extended interior 106 of the cutter 100. However, the malleable compounds 120 does not extrude through the mesh 42 outside of the open extended interior 106. FIG. 20 depicts resulting shaped malleable compound 134 that remains positioned atop the mesh 42 following extrusion of the compound 120 through the mesh when the cutter 100 is removed. In addition, FIG. 20 reveals a cutout 132 in the sheet 122 as well as the shaped and extruded material 134. This process may be repeated with malleable compounds of various colors and thicknesses to create art on mesh 42 within the major frame 16. For example, where multiple shaped malleable compounds 134 are positioned over one another, the formed art has a three dimensional structure.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Moreover, the order of the components detailed in the system may be modified without limiting the scope of the disclosure.

We claim:

1. An apparatus for shaping a malleable compound, the apparatus comprising:
a minor frame;
a mesh secured to the minor frame, the mesh comprising an upper surface and a lower surface;
at least one cutter having a lower edge defining a pattern, an upper surface and an open extended interior spanning between the lower edge and the upper surface; wherein when the lower edge of the cutter is placed over the mesh atop the malleable compound and manual pressure is applied to the cutter, the malleable compound extrudes through the mesh past the lower edge and into the open extended interior of the cutter resulting in the malleable compound taking on a shape of the pattern.

2. The apparatus of claim 1, further comprising a major frame, the minor frame being configured to engage within the major frame to position the mesh therein.

3. The apparatus of claim 2, wherein the major frame is further comprised of a major frame top member and a major frame bottom member.

4. The apparatus of claim 3, wherein the minor frame is secured in position between the major frame top member and the major frame bottom member and the major frame top member is detachably secured to the major frame bottom member with at least one attachment member.

5. The apparatus of claim 1, wherein a hole size of the mesh is in a range of from about 0.057 inches in diameter to 0.125 inches in diameter.

6. The apparatus of claim 1, wherein an open area of the mesh is in a range of about 37 percent open to 65 percent open.

7. The apparatus of claim 1, wherein the mesh is tensioned within the minor frame.

8. The apparatus of claim 1, wherein the shape of the lower edge of the cutter is selected from the group consisting of a star, a circle, a heart, a triangle and a square.

9. The apparatus of claim 1, wherein the open extended interior is bounded by a wall spanning between the upper surface and the lower edge.

10. The apparatus of claim 9, wherein the manual pressure is applied to either or both of the upper surface and the wall spanning between the upper surface and the lower edge.

11. The apparatus of claim 1, further comprising a tray removably positioned beneath the minor frame to support the malleable compound.

12. A system for extruding a malleable compound into a desired shape, the system comprising:
a major frame with an upper major frame member and a lower major frame member;
a minor frame with an interior perimeter and an outer perimeter, the minor frame disposed between the upper major frame member and the lower major frame member;
a mesh secured proximate the interior perimeter of the minor frame, the mesh comprising an upper surface and a lower surface;
a tray disposed beneath the mesh and operably separable from the major frame, mesh and minor frame;
a cutter of a desired pattern with a lower edge, an upper surface and an open extended interior spanning between the lower edge and the upper surface; wherein the lower edge of the cutter is placed over the mesh atop the malleable compound and manual pressure is applied to the cutter causing the malleable compound to extrude through the mesh past the lower edge into the open extended interior of the cutter resulting in the malleable compound taking on a shape of the desired pattern.

13. The system of claim 12, wherein the malleable compound is extruded into the open extended interior beginning with an initial application of the manual pressure until a maximum downward flexure of the mesh is achieved.

14. The system of claim 12, wherein the malleable compound extruded into the open extended interior is removed from the open extended interior.

15. The system of claim 12, wherein the manual pressure is applied to either or both of the upper surface and a wall spanning between the upper surface and the lower edge.

16. A method for extruding a malleable compound into a desired shape, the method comprising:
depositing the malleable compound beneath a taut mesh;
positioning a lower patterned edge of a cutter against an upper surface of the mesh and over the malleable compound;
depressing the mesh with the lower patterned edge of the cutter;
extruding the malleable compound through the mesh and into an open extending interior space of the cutter; and
removing the shaped malleable compound from the interior space of the cutter to free a shape defined by the lower patterned edge of the cutter.

17. The method of claim 16, wherein the step of depositing the malleable compound into a tray beneath the taut mesh further comprises flattening the malleable compound into a sheet.

18. The method of claim 16, wherein the shape defined by the patterned lower edge of the cutter is selected from the group consisting of a star, a circle, a heart, a triangle and a square.

19. The method of claim 16 wherein the step of removing the shaped malleable compound from the open extending interior space of the cutter is performed manually.

20. The method of claim 16, wherein a mesh material is tensioned within a minor frame to form the taut mesh, and, a horizontal and vertical midpoint of the mesh secured to a minor frame interior perimeter is capable of flexure with hand applied pressure.
